(19) United States
(12) Patent Application Publication
(10) Pub. No.: US 2005/0098502 A1
(43) Pub. Date: May 12, 2005

(54) Psoriasis formulation and method of preparation

(76) Inventor: Edward Houston, Glasgow (GB)

Correspondence Address: EDWARDS & ANGELL, LLP, P.O. BOX 55874, BOSTON, MA, 02205, US

(21) Appl. No.: 10/662,553

(22) Filed: Sep. 15, 2003

(30) Foreign Application Priority Data
Jul. 25, 2002 (GB) GB0217372.2
Jul. 21, 2003 (GB) GB2003/003257

(51) Int. Cl. B01D 37/00

(52) U.S. Cl. 210/660; 210/767; 424/69

(57) ABSTRACT

Formulations which can be used in the treatment of dermatological disorders, in particular psoriasis and methods of preparation of said formulations that is more acceptable for use and produces a more user friendly composition utilizing coal tar.

### CROSS-REFERENCE TO RELATED APPLICATION

This application claims priority to United Kingdom Patent Application No. 0217372.2, filed Jul. 25, 2002, which is the basis for Internatonal Patent Application No. GB2003/003257, filed Jul. 18, 2003, each of which is incorporated herein by reference.

### BACKGROUND OF THE INVENTION

1. Field of the Invention

This invention relates to formulations which can be used in the treatment of dermatological disorders, such as psoriasis. The current invention also relates to a method of preparation that is more acceptable for use than many current treatments.

2. Background of the Related Art

The term dermatological disorders covers a wide range of disorders, such as psoriasis and eczema. These disorders affect a large number of people. Psoriasis is a chronic recurring skin disease, the scope of which can vary considerably from mild outbreaks, to severe cases.

The underlying problem of psoriasis is currently thought to be that new skin cells are produced too quickly, so that the old skin cells have not had time to die off and be removed. The resulting overproduction of skin cells is red and raised patches on the skin.

Various treatments have been suggested for psoriasis. In particular, many sufferers find that coal tar has a particularly beneficial effect and improves many of the symptoms of psoriasis. Unfortunately, although coal tar has been found to be effective against the symptoms of psoriasis in many patients, as a substance coal tar is not the most user friendly. Coal tar has a very pungent smell and has a black colour which stains both clothing and bed linen. This can be very off-putting for many psoriasis sufferers and is generally inconvenient for regular use.

It can therefore be seen that it would be beneficial to provide a psoriasis treatment which contains coal tar, but which is formulated in a manner which is appropriate for regular use.

### SUMMARY OF THE INVENTION

It is an object of the present invention to provide a psoriasis treatment which comprises coal tar.

A further object of the present invention is to provide a psoriasis treatment in a formulation which does not stain clothes and is not unpleasant smelling.

A yet further object of the present invention is to provide a psoriasis treatment in a formulation that can be easily applied.

According to a first aspect of the present invention, there is provided a method of preparing a composition for the treatment of dermatological disorders, wherein coal tar is filtered to remove impurities by filter compression.

Preferably zinc pyrithione is incorporated into the composition.

Preferably the coal tar is filtered by being fed through a compressed charcoal filter.

Most preferably the coal tar is fed through the filter at 17 to 19 psi.

Most preferably the coal tar is fed through the filter at 18 psi.

Preferably compressed air is used to force the coal tar through the filter.

Preferably the coal tar is left in the filter system for 8 hours.

Preferably the fluid that has been passed through the filter is boiled.

Most preferably the fluid is boiled for 5 minutes.

Preferably the boiled, filtered fluid is allowed to cool to room temperature.

Most preferably the top layer of the boiled, filtered fluid is refiltered.

Optionally, refiltering is through a nylon mesh.

Preferably a surfactant is added to the formulation.

Preferably the surfactant is an ionic surfactant.

Most preferably the surfactant is sodium lauryl sulphate.

Preferably a carrier is added to the formulation.

Most preferably multiple carriers are added to the formulation.

Optionally a carrier may be isopropyl myristate.

A further option is that a carrier may be ethyl alcohol.

Preferably the formulation is placed in a spray or aerosol container.

Preferably a mild steroid is added to the formulation.

Preferably the mild steroid is 0.05% dipropionate.

According to a second aspect of the present invention, there is provided a composition for the treatment of dermatological disorders, comprising:
coal tar;
zinc pyrithione;
one or more surfactants; and
one or more carriers.

Preferably the dermatological disorder is psoriasis.

Preferably the composition also contains allantoin.

Preferably the surfactant is an ionic surfactant.

Most preferably the surfactant is sodium lauryl sulphate.

Optionally a carrier may be isopropyl myristate.

A further option is that a carrier may be ethyl alcohol.

Preferably the composition will also comprise an anti-fungal agent.

Preferably the anti-fungal agent is undecylenic acid.

Preferably the composition formulation comprises the following ingredients:
zinc pyrithione;
alcoholic extract of coal tar;
allantoin;
sodium lauryl sulphate;
isopropyl myristate;
ethyl alcohol; and
undecylenic acid.

Optionally the composition formulation comprises a mild steroid.

Preferably the mild steroid is dipropionate.

Preferably the mild steroid is 0.05% dipropionate.

Preferably the composition comprises the following ingredients in the following amounts:

| | |
|---|---|
| zinc pyrithione | 0.20% |
| alcoholic extract of coal tar | 0.25% |
| allantoin | 0.25% |
| sodium lauryl sulphate | 0.10% |
| isopropyl myristate | 49.45% |
| ethyl alcohol | 49.45% |
| undecylenic acid | 0.30%. |

Preferably the composition is provided in a spray form.

Alternatively, the composition is provided in an aerosol form.

### BRIEF DESCRIPTION OF THE FIGURE

In order to provide a better understanding of the present invention, embodiments will now be described by way of example only, and with reference to the following Figure:

FIG. 1 shows a charcoal filter system for use according to the first aspect of the present invention.

### DETAILED DESCRIPTION OF THE PREFERRED EMBODIMENTS

Coal tar, when untreated, has a very pungent smell and is black in colour. The black colouring will stain clothing and bed linen on contact.

In order to produce an acceptable formulation for use in treating psoriasis or other dermatological disorders, coal tar is filtered in order to eradicate the smell and remove many of the impurities which result in staining.

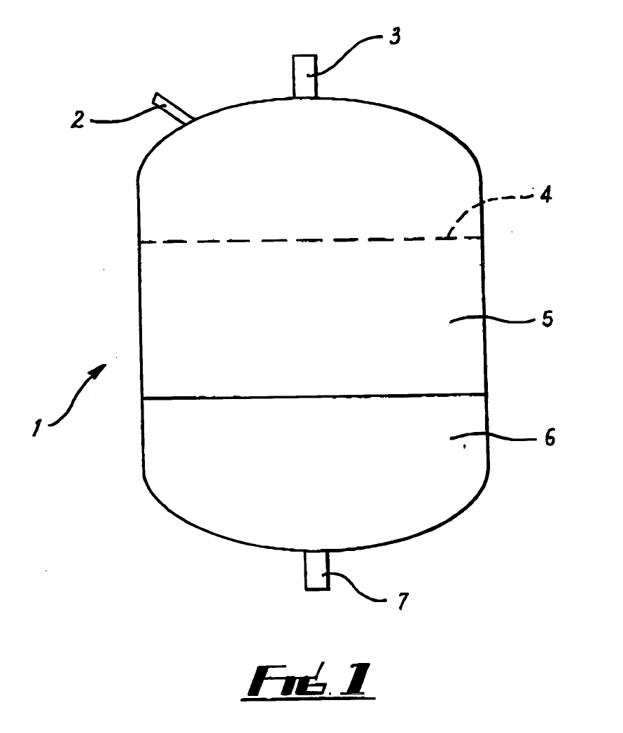

Referring to FIG. 1, in the preferred embodiment, crude coal tar is mixed with 2% sd alcohol (which acts as a thinner and is poured into a charcoal filter system 1 via the coal tar input 2. Clean, compressed air is then applied via the air input 3 at 18 psi (which can be varied between 17 to 19 psi).

The charcoal filter system 1 comprises a fine mesh gauze filter 4 and a charcoal filter 5 which the coal tar mixture is pushed through into the catch tank 6. It is worth noting that too much pressure forces charcoal through the system and too little does not push the coal tar mixture through.

The system 1 is left in place overnight with the compressed air still in place. In the preferred embodiment, the system is left for approximately 8 hours. The filtered fluid is then taken from the catch tank 6 via the exit flow tap 7 and is boiled (in the preferred embodiment it is boiled for 5 minutes) and left to completely cool to room temperature. The fluid now has a scum on top which is filtered through a nylon mesh to give a clear, completely odourless liquid which does not stain materials.

A surfactant and a carrier is then added to make the formulation completely soluble. In the preferred embodiment, the surfactant is an ionic surfactant, sodium lauryl sulphate. Multiple carriers are used, and in the preferred embodiment, these are isopropyl myristate and ethyl alcohol. Zinc pyrithione is also added to the formulation, which increases the effectiveness of the formulation to a previously unexpected degree. Allantoin is also added to the formulation.

In the preferred embodiment, an anti-fungal agent is also added to the formulation. This anti-fungal agent is undecylenic acid in the preferred embodiment.

While the invention has been described with respect to preferred embodiments, those skilled in the art will readily appreciate that various changes and/or modifications can be made to the invention without departing from the spirit or scope of the invention as defined by the appended claims.

1-32. (canceled)

33. A method of preparing a composition for the treatment of dermatological disorders, comprising the steps of: filtering coal tar to remove impurities by filter compression and preparing a composition wherein the composition includes the filtered coal tar.

34. A method as in claim 33, further comprising the step of adding zinc pyrithione into the composition.

35. A method as in claim 33, wherein the coal tar is filtered by being fed through a compressed charcoal filter.

36. A method as in claim 35, wherein the coal tar is fed through the filter at approximately 17 to 19 psi.

37. A method as in claim 35, wherein the coal tar is fed through the filter at approximately 18 psi.

38. A method as in claim 35, further comprising the step of using compressed air to force the coal tar through the compressed charcoal filter.

39. A method as in claim 35, further comprising the step of leaving the coal tar in the compressed charcoal filter for 8 hours.

40. A method as in claim 35, further comprising the step of boiling a fluid that has been passed through the compressed charcoal filter.

41. A method as in claim 40, wherein the fluid that has been passed through the compressed charcoal filter is boiled for 5 minutes.

42. A method as in claim 40, wherein the boiled, filtered fluid is allowed to cool to room temperature.

43. A method as in claim 40, further comprising the step of refiltering a top layer of the boiled, filtered fluid.

44. A method as in claim 43, wherein refiltering is through a nylon mesh.

45. A method as in claim 33, where a surfactant is added to the formulation.

46. A method as in claim 45, wherein the surfactant is an ionic surfactant.

47. A method as in claims 45, wherein the surfactant is sodium lauryl sulphate.

48. A method as in any claim 33, wherein a carrier is added to the formulation.

49. A method as in claim 48, wherein the carrier is isopropyl myristate.

50. A method as in claim 48, wherein the carrier is ethyl alcohol.

51. A method as in claim 33, further comprising the step of placing the composition in a container selected from the group consisting of a spray container and an aerosol container.

52-65. (canceled)

66. A method as in claim 35, wherein a plurality of carriers are added to the formulation.
